(19) United States
(12) Patent Application Publication
(10) Pub. No.: US 2008/0243411 A1
(43) Pub. Date: Oct. 2, 2008

(54) Method for monitoring the optical transmissibility through an observation window and device for cleaning an observation window

(76) Inventors: Heinz Pritzke, Kesselsdorf Ot Braunsdorf (DE); Joachim Mannhardt, Eschach (DE)

Correspondence Address: JACOBSON HOLMAN PLLC, 400 SEVENTH STREET N.W., SUITE 600, WASHINGTON, DC, 20004, US

(21) Appl. No.: 12/076,814

(22) Filed: Mar. 24, 2008

(30) Foreign Application Priority Data
Mar. 28, 2007 (DE) 10 2007 014 844.7

(51) Int. Cl. G06F 19/00

(52) U.S. Cl. 702/82

(57) ABSTRACT

The invention relates to a method and a device for monitoring the optical transmissibility of an observation window (2) for the spectroscopic analysis of the homogeneity of a mixture material in a mixing container. According to the method, a product-specific limit value for the spectroscopic data is stored in the analysis unit, which limit value must be undershot within a prespecified time. If the data does not fall below the limit value within that time, the analysis unit emits a signal which contains information to the effect that the observation window (3) is soiled to an unacceptable degree.

The device comprises an analysis unit in which product-specific limit value for the spectroscopic data can be stored, a cleaning device for cleaning the observation window and a switching unit for activating the cleaning device. The analysis unit is suitable for emitting a signal if the limit value is not undershot during the mixing process within a prespecified time. The analysis unit is connected to the switching unit such that, if the signal is present, the switching unit can activate the cleaning device.

The invention relates to a method for monitoring the optical transmissibility of an observation window as claimed in the preamble of claim 1, and to a device for cleaning an observation window as claimed in claim 3.

When mixing a plurality of pulverulent or granular products, in particular in the pharmaceutical industry, the process progression is increasingly monitored and controlled in the sense of PAT (Process Analytical Technology) using spectroscopic or photometric methods. It is a target here to determine the mixing quality and, consequently, the time the mixing process finishes by way of an online analysis. Conventional analysis methods are optical, acoustic and terahertz spectroscopy. In the optical methods, the UV-VIS, NIR reflection spectroscopy and fluorescence spectroscopy are used.

The mixing processes must inevitably be observed through an observation window. The spectroscopic analysis is here carried out at the position of the mixer if the mixture material is located on the observation window. The analysis can also be carried out continuously, wherein the measurement results which deviate from the real values since the mixture material is not located on the observation window are filtered out by appropriate software.

### PRIOR ART

According to the prior art, various applications of spectroscopic methods in mixing processes are known. By way of example, EP 1 265 694 B1 discloses an apparatus and a method for mixing components which are usually present in pulverulent form. The apparatus comprises a vessel for receiving the components, drive means for rotating the vessel about an axis to effect mixing of the components within the vessel, and at least one spectroscopic monitoring means for repeatedly monitoring changes in the spectroscopic profile of the mixture as mixing proceeds, wherein the monitoring means can be positioned in a positionally correct manner with respect to a window in the vessel. The monitoring means can be arranged directly or indirectly on the vessel.

It is possible in all methods and apparatuses of this type for deposits or soiling on the window in the vessel to occur during the mixing process. Soiling of this type, however, cannot be ascertained and cannot be distinguished either in the analysis signal of the mixture material. It leads to a negative influence of the transmission characteristic of the window and to erroneous measurement values.

Various methods are known for measuring the degree of soiling of a window. DE 35 21 737 A1 specifies a control apparatus for ascertaining the degree of the transparency of panes, in particular of windshields in motor vehicles. A measurement apparatus for the degree of soiling with at least one light-dependent transducer and a comparison circuit can activate a cleaning apparatus. The apparatus has a periodically opening shutter or flap.

JP 08068754 A specifies a method for measuring the transparency of a monitoring pane in a plasma etching device. The interchangeable monitoring pane made of fused glass is irradiated obliquely from the outside using a predetermined light, and the reflected light is measured by an optical sensor. The process data is evaluated and displayed by a computer.

DE 195 41 516 C2 specifies an apparatus for the optical “in situ” determination of the oxygen concentration, on which a soiling monitoring means is provided. A diode laser radiates light through the test volume and a photodiode detects the transmitted radiation, the signal thereof being demodulated using double the modulation frequency, which signal is directly proportional to the absorption strength and thus to the concentration of the oxygen in the test volume. In a second beam path which is parallel thereto, another diode laser with a wavelength that is different from the absorption wavelength and another photodiode are provided whose signal is used for soiling correction of the signal obtained in the measurement beam path from the photodiode.

### OBJECT OF THE INVENTION

It is therefore an object of the invention to specify a method for monitoring the transmission characteristic of the observation window and a device for cleaning the observation window for methods and devices for the application of spectroscopic or photometric methods in mixing processes in a mixing container according to the prior art. It is not important for the invention here whether a spectroscopic or photometric method is used. Consequently, the following text, including the claims, generally only refers to spectroscopic methods.

The invention achieves the object for the method by virtue of the features specified in claim 1. The object for the device is achieved by virtue of the features in claim 3. Advantageous developments of the invention are characterized in the respective subclaims and are illustrated in more detail below together with the description of the preferred embodiment of the invention, including the drawing.

The method according to the invention is used at the same time as a known method of the spectroscopic analysis of the homogeneity of a mixture material in a mixing container via an observation window. The sensor is positioned outside the mixing container on the observation window and the spectroscopic data of the mixture material is detected during the mixing continuously or periodically.

According to the invention, a product-specific limit value for the spectroscopic data is stored in the analysis unit. Said limit value is determined by the spectroscopic data which is to be expected for the mixture material when the mixture material is located on the observation window and, in contrast, when the observation window is free from mixture material. Furthermore, a time within which the spectroscopic data must fall below the product-specific limit value is prespecified as a function of the technological values of the mixing process, in particular the rotary speed of the mixing container. That means that if the data signals fall below the limit value, low or, in the most favourable case, no spectroscopic data is measured on the observation window. This means that the observation window is devoid of obstructing deposits and is thus clean.

If, on the other hand, the data signals have not fallen below the product-specific limit value within a prespecified time, this means that there are deposits of the mixture material on the observation window and the measurements are wrong or inaccurate. In this case, the analysis unit emits a signal which contains the information that the observation window is soiled to an unacceptable degree. More detailed statements are made in exemplary embodiment I.

In the simplest case, the signal of the analysis unit can be intended as an audible or visual signal for the plant operator to the effect that the latter initiates appropriate measures for cleaning the observation window.

According to claim 2, a solution is proposed to the effect that the signal of the analysis unit is fed to a switching unit which activates a cleaning apparatus for cleaning the inside surface of the observation window.

The devices for cleaning the observation window for the spectroscopic analysis of the homogeneity of a mixture material in a mixing container comprises an analysis unit whose sensor is positioned outside the mixing container on the observation window. According to the invention, a cleaning device for cleaning the observation window and a switching unit for activating the cleaning device are present.

Furthermore, the analysis unit has a memory in which a product-specific limit value for the spectroscopic data can be stored, which limit value is determined by way of the spectroscopic data which is to be expected for the mixture material when the mixture material is located on the observation window and when the observation window is free from mixture material. The analysis unit is suitable for emitting a signal if the product-specific limit value is not undershot during the mixing process within a prespecified time. The analysis unit is connected to the switching unit such that, if the signal is present, the switching unit can activate the cleaning device.

A mechanical wiping apparatus using a segment rotary wiper or a linear wiper can be present as the cleaning device. The cleaning device can also be in the form of a vibrator which is arranged outside the mixing container and is connected to the observation window. The vibrator is suitable for causing the observation window to vibrate such that deposits fall off due to force of gravity. It is important in the application of the invention that the wiping apparatus or the vibrator are only in operation if a position sensor for the position of the mixture material provides a signal to the effect that there is no mixture material on the observation window. To this end, the position sensor is connected to the switching unit such that the cleaning device can only be activated if the signal of the analysis unit and the signal of the position sensor are both present at the switching unit at the same time.

The technical designs of the wiper or of the vibrator can vary within the framework of the generally known prior art. The wiper can carry out a rotary movement or a linear movement. The wiper will usually have an elastic wiper strip which is in direct contact with the observation window and gently wipes away the deposit.

If a vibrator is used it is advantageous that the observation window is elastically held in the wall of the mixing container or the wall is sufficiently elastic. In practice it has also been possible to find evidence of an elasticity on larger containers having correspondingly thicker walls, which is sufficient for the application of a vibrator.

### EXEMPLARY EMBODIMENTS

The method and the device will be explained in more detail below in three exemplary embodiments. In association with exemplary embodiment I, FIG. 1 shows a pivot wiper, with exemplary embodiment II, FIG. 2 shows a rotary window and FIG. 3 shows a pivot pane in relation to exemplary embodiment III.

### Exemplary Embodiment I

In exemplary embodiment I with FIG. 1, an observation window 2 is arranged in the container wall 1 of a mixing container such that the observation window 2 is approximately on the same plane as the inner surface of the container wall 1 or is slightly raised with respect to the latter.

A sensor 3, which is associated with the analysis unit for the spectroscopic analysis of the homogeneity of the mixture material in the mixing container, is held by a holding device 4 outside on the container wall 1 and along the axis 5 of the observation window 2. The component which is referred to as sensor 3 for simplification purposes, can in practice include further components in cooperation with the analysis unit. The electrical connection between the analysis unit (not shown) and the sensor 3 is established via a connecting cable 10.

Furthermore, a pivot shaft 7, at whose inner end a pivot wiper 8 is provided, is mounted parallel to the axis 5 in the holding device 4. The pivot wiper 8 has a wiping element 9 in the direction of the observation window 2.

For operating the pivot wiper 8, any desired pivot device (not illustrated in the drawing) which is connected to the pivot shaft 7 and can be controlled by a signal from the analysis unit is provided outside the mixing container.

The device will be explained in more detail below in the application of the method of the invention. According to the prior art, various pulverulent starting products are introduced into the mixing container and mixed by rotation. The method progression is monitored and controlled, by way of example, using the method of the NIR reflection spectroscopy. According to the invention, a product-specific limit value for the spectroscopic data is here stored in the analysis unit, which limit value is determined by the spectroscopic data which is to be expected for the mixture material when the mixture material is located on the observation window 2 and when the observation window 2 is free from mixture material. A time within which the spectroscopic data must fall below the product-specific limit value is prespecified as a function of the technological values of the mixing process. That means that the spectroscopic data are available if the mixture material is located on the observation window 2. As mixing proceeds, if the observation window 2 is moved upward by rotation, the mixture material falls off in the mixing container and the observation window 2 is theoretically free from mixture material. In this position, the spectroscopic data must fall below the product-specific limit value because there is no mixture material on the window.

If, however, the product-specific limit value of the spectroscopic data is not undershot within a prespecified time which is determined by the rotary speed of the mixing container, this is a sign that there are deposits of the mixture material on the inner surface of the observation window 2, which deposits falsify the spectroscopic measurement data. In this case, the analysis unit emits a signal which contains the information that the observation window is soiled to an unacceptable degree.

In addition, in exemplary embodiment I, the pivot device for operating the pivot shaft 7 is activated and the pivot wiper 8 is moved, for example, three times over the observation window 2 so that the wiping element 9 removes deposits of mixture material which adhere on the observation window 2 in an undesired manner.

### Exemplary Embodiment II

In connection with exemplary embodiment II, FIG. 2 shows a rotary window 11 as observation window, which is mounted via a shaft 12, in a manner similar to exemplary embodiment I, in the holding device 4 for the sensor 3. An opening 13 with a sealing ring 14 is provided in the container wall 1. The opening 13 is sealed externally by the rotary window 11, wherein the rotary window 11 is guided in a window retainer 15 such that it can rotate. The holding device 4 and the window retainer 15 are, in practice, designed as structural unit.

In the application of the device according to the method of the invention, as is described in exemplary embodiment I, the shaft 12 is set in motion, as a result of which the rotary window 11 is rotated past the opening 13 with the sealing ring 14. Any deposits of mixture material which are present on the rotary window 11 are removed by the sealing ring 14 in the process. As a result, a clean rotary window 11 is located in front of the sensor 3 in the inactive state.

### Exemplary Embodiment III

In exemplary embodiment III with the associated FIG. 3, an opening 16 is provided in the container wall 1, similar to the exemplary embodiment II. Here, the opening 16 is arranged in a window guide 17 which guides a pivot pane 19 outside of the mixing container. The opening 16 is surrounded by a circular ring 18 at the window guide 17. The sensor 3 rests against the pivot pane 19 from the outside. In accordance with the method process described in exemplary embodiments I and II, during operation the pivot pane 19 is pivoted in directions according to the direction arrows 20. If deposits of the mixture material are present in the region of the opening 16, they are wiped away on the circular ring 18 if the pivot pane 19 moves.

The exemplary embodiments II and III are particularly suitable on mixing containers for sensitive products which need frequent effective cleaning. By contrast with the solution according to exemplary embodiment I, these solutions have fewer gaps and covered regions which are accessible during cleaning only with difficulty.

List of reference symbols used

| | | | |
|---|---|---|---|
| 1 | container wall | 2 | observation window |
| 3 | sensor | 4 | holding device |
| 5 | axis | 6 | |
| 7 | pivot shaft | 8 | pivot wiper |
| 9 | wiping element | 10 | connecting cable |
| 11 | rotary window | 12 | shaft |
| 13 | opening | 14 | sealing ring |
| 15 | window retainer | 16 | opening |
| 17 | window guide | 18 | circular ring |
| 19 | pivot pane | 20 | direction arrow |

1. A method for monitoring the optical transmissibility of an observation window (2) for the spectroscopic analysis of the homogeneity of a mixture material in a mixing container, having an analysis unit whose sensor (3) is positioned outside the mixing container on the observation window (2) in which the spectroscopic data of the mixture material is detected during the mixing continuously or periodically, wherein
a product-specific limit value for the spectroscopic data is stored in the analysis unit, which limit value is determined by the spectroscopic data which is to be expected for the mixture material when the mixture material is located on the observation window (2) and when the observation window (2) is free from mixture material,
a time within which the spectroscopic data must fall below the product-specific limit value is prespecified as a function of the technological values of the mixing process, and
the analysis unit emits a signal if the spectroscopic data has not fallen below the product-specific limit value within the prespecified time, which signal contains the information that the observation window (2) is soiled to an unacceptable degree.

2. The method as claimed in claim 1, wherein the signal of the analysis unit is fed to a switching unit which activates a cleaning apparatus for cleaning the inside surface of the observation window (2).

3. A device for cleaning an observation window (2) for the spectroscopic analysis of the homogeneity of a mixture material in a mixing container, having an analysis unit whose sensor (3) is positioned outside the mixing container on the observation window (2), wherein
a cleaning device for cleaning the observation window and
a switching unit for activating the cleaning device are provided,
the analysis unit has a memory in which a product-specific limit value for the spectroscopic data can be stored, which limit value is determined by way of the spectroscopic data which is to be expected for the mixture material when the mixture material is located on the observation window (2) and when the observation window (2) is free from mixture material,
the analysis unit is suitable for emitting a signal if the product-specific limit value is not undershot during the mixing process within a prespecified time, and
the analysis unit is connected to the switching unit such that, if the signal is present, the switching unit can activate the cleaning device.

4. The device as claimed in claim 3, wherein a mechanical wiping apparatus with a pivot wiper (8), a rotary window (11) as observation window in contact with a sealing ring (14) or a pivot pane (19) as observation window in contact with a sealing ring (18) is provided as the cleaning device.

5. The device as claimed in claim 3, wherein a vibrator is provided as the cleaning device, which is arranged outside the mixing container and is connected to the observation window.

6. The device as claimed in claim 3, wherein a position sensor is present, which emits at least one signal if the position of the mixing container is such that there is no mixture material on the observation window.

7. The device as claimed in claim 6, wherein the position sensor is connected to the switching unit such that the cleaning device can only be activated if the signal of the analysis unit and the signal of the position sensor are both present at the switching unit at the same time.
